(19) United States
(12) Patent Application Publication
(10) Pub. No.: US 2026/0330381 A1
(43) Pub. Date: Oct. 22, 2026

(54) SCENARIO TABLETOP SIMULATION CO-PILOT

(71) Applicant: Fusion Risk Management, Inc., Chicago, IL (US)

(72) Inventors: Robert Davis DeRodes, Morrisville, NC (US); Zack Keller, Chicago, IL (US); James Post, Houston, TX (US); Sean McLaughlin, Covington, WA (US)

(73) Assignee: Fusion Risk Management, Inc., Chicago, IL (US)

(21) Appl. No.: 19/182,530

(22) Filed: Apr. 17, 2025

(51) Int. Cl. G06Q 10/0637; G06F 9/451; G06F 40/284; G10L 15/26

(52) U.S. Cl. CPC G06Q 10/0637; G06F 9/451; G06F 40/284; G10L 15/26

(57) ABSTRACT

Tabletop scenario co-piloting includes selecting a scenario as a subject of a tabletop scenario collaborative activity and tuning an initial prompt as a combination of the selected scenario and a directive to produce an indication of an adverse event associated with the selected scenario. The tuned initial prompt is submitted to an LLM which returns in response an indication of the adverse event for presentation by a business continuity management system in an associated user interface. A specification of a reaction to the adverse event is received in the user interface and a subsequent prompt is tuned with the reaction and submitted to the LLM. In reply, the LLM provides an indication of a further adverse event and the business continuity management system presents the indication of the further adverse event in the user interface. This process repeats as the basis of a tabletop scenario co-pilot supported exercise.

### BACKGROUND OF THE INVENTION

### Field of the Invention

The present invention relates to the technical field of business continuity planning and disaster recovery and more particularly to the integration of a large language model (LLM) in a business continuity management system.

### Description of the Related Art

Business continuity planning refers to the planning involved in a business organization addressing prospective adverse events so as to ensure the continuous operation of the organization during the course of such adverse events. Disaster recovery planning is an extension of business continuity planning in which mechanisms and requirements are specified in order to promote the recovery of an organization impacted by an adverse event. Historically, both business continuity planning and disaster recovery planning have been manually processes performed by a team of analysts crafting and completing spreadsheet-like what-if analyses in regard to different disaster scenarios imagined by the planning team. More recently, however, much of business continuity planning has been automated.

In this regard, automated business continuity and disaster recovery planning tools tap information in a database cataloging different organizational assets with different exposures to different adverse events and process those assets against a specified scenario involving one or more of the adverse events. This processing generally results in the production of a manifest of assets exposed to the one or more adverse events of the specified scenario. The manifest, in turn, may be processed against pre-stored data in order to enumerate a cost of the impact of the one or more of the adverse events upon the assets of the manifest, and a time required to return those of the impacted assets to nominal operating condition. As such, a team reviewing the automated analysis can simulate an improvement in preparedness for the scenario by modifying the characterization of one or more of the assets in the manifest in order to lower the cost of impact, reduce the time required to return the impacted assets to nominal operating condition, or both.

An important aspect of preparedness for a disaster scenario is the table top testing and simulation exercise. Table top testing, also known as a table top exercise (TTX) or table top scenario, is a low-stress, discussion-based session where participants practice their roles and responsibilities in response to a simulated emergency which can range from natural disasters, to cyberattacks, to public health crises, or even terrorist incidents. The purpose of the table top scenario testing exercise is to assess the disaster recovery and business continuity plans of an organization, its procedures and, of great importance, coordination mechanisms between both internal groups of the organization and groups external to the organization. With the table top scenario testing exercise, the organization can then identify those strengths, weaknesses, and areas for improvement in response to a disaster scenario.

Central to the table top scenario testing exercise are the participants including key personnel assigned to emergency management roles and responsibilities, a facilitator who controls the pace and flow of the exercise, and stimulates discussion, an evaluator who identifies strengths and areas for improvement, and assists in developing an after action report and observers who participate when called upon. As it will be understood, then, the effectiveness of table top scenario testing largely depends upon the skill and knowledge base of the participants. Consequently, the complex relationships between the adverse events of a scenario, and the impact of inoperable assets upon other assets of an organization can be easily overlooked owing to the analytical throughput limitations of the human participants to the scenario table top scenario testing exercise.

### BRIEF SUMMARY OF THE INVENTION

Embodiments of the present invention address technical deficiencies of the art in respect to the analytical throughput limitations of the human participants to the scenario table top scenario testing exercise. To that end, embodiments of the present invention provide for a novel and non-obvious method for tabletop scenario co-piloting in order to assist the human participants in advancing analytical throughput to dynamically simulate the complex interrelationships between assets and adverse events of a scenario subject to table top testing. Embodiments of the present invention also provide for a novel and non-obvious computing device adapted to perform the foregoing method. Finally, embodiments of the present invention provide for a novel and non-obvious data processing system incorporating the foregoing device in order to perform the foregoing method.

In one embodiment of the invention, a method for tabletop scenario co-piloting includes the establishment of a communicative coupling over a computer communications network between a computer-generated business continuity management user interface of the business continuity management system and a selected large language model (LLM) that has been trained to correlate different adverse events with the occurrence of other adverse events and the impact of one or more reactive actions upon the adverse events. The method further includes the selection by the participants through the user interface of a scenario as the subject of a tabletop scenario collaborative activity. Thereafter, the method includes the tuning of an initial prompt as a combination of the selected scenario and a directive to produce an indication of an adverse event associated with the selected scenario. The tuned initial prompt is then submitted over the communicative coupling to the LLM.

In reply to the tuned initial prompt, the LLM returns an indication of the adverse event and the business continuity management system then presents the indication of the adverse event in the user interface. Once the business continuity management system has presented the indication of the adverse event in the user interface, a specification of a reaction to the adverse event may be received in the user interface. In response, a subsequent prompt is tuned with the reaction and submitted over the communicative coupling to the LLM. Then, in reply, an indication of a further adverse event is received and the business continuity management system again presents the indication of the further adverse event in the user interface. This process repeats one or more additional times as the basis of a tabletop scenario co-pilot supported exercise.

In one aspect of the embodiment, a summary document can be generated which documents a sequence of prompts and replies of the tabletop scenario collaborative activity with the document being persisted to persistent storage in connection with the selected scenario. In another aspect of the embodiment, audio input of the tabletop scenario collaborative activity can be received and submitted to a speech recognition engine to produce a transcript of the tabletop scenario collaborative activity so that the transcript can be persisted in the persistent storage in connection with the tabletop scenario collaborative activity.

In yet another aspect of the embodiment, individual tokens of the summary document can be extracted and filtered to exclude stop words. Then, the filtered tokens can be indexed to include unique instances of words including a frequency of appearance of each of the unique instances of the words. Finally, the index is stored in the persistent storage in connection with the tabletop scenario collaborative activity. Optionally, a multiplicity of different indices stored in the persistent storage can be retrieved in connection a corresponding tabletop scenario collaborative activity for a common scenario. Then, ones of the unique instances of the words with a threshold frequency of appearance in different ones of the indices can be identified a flag assigned for others of the indices in which the unique instances of the words lack the threshold frequency.

In another embodiment of the invention, a data processing system is adapted for tabletop scenario co-piloting. The system includes a host computing platform of one or more computers, each with memory and one or processing units including one or more processing cores. The system also includes a business continuity management system that executes in the memory of the host computing platform and generates during execution, a user interface through which data input is received for the business continuity management system and through which data output is provided by the business continuity management system. The system yet further includes a communicative coupling between the host computing platform and an LLM. Finally, the system includes a tabletop scenario co-piloting module.

The module includes computer program instructions enabled while executing in the memory of at least one of the processing units of the host computing platform to select in the user interface a scenario as a subject of a tabletop scenario collaborative activity. The program instructions further tune an initial prompt as a combination of the selected scenario and a directive to produce an indication of an adverse event associated with the selected scenario. Then, the program instructions submit the tuned initial prompt over the communicative coupling to the LLM so as to receive in reply, the indication of the adverse event. The business continuity management system then presents the indication of the adverse event in the user interface. Subsequently, the program instructions receive through the user interface a specification of a reaction to the adverse event and the program instructions in response, tune a subsequent prompt with the reaction, submit the tuned subsequent prompt over the communicative coupling to the LLM, receive in reply, an indication of a further adverse event, so that the the business continuity management system presents the indication of the further adverse event in the user interface. Finally, the program instructions the foregoing subsequent steps a discrete number times.

In this way, the technical deficiencies of the conventional table top scenario testing exercise are overcome owing to the continuous testing of adverse reaction events with new adverse event variations produced by the LLM without requiring the individual participants to know a priori the complex relationships between the adverse events of a scenario, and the impact of inoperable assets upon other assets of the organization.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration reflecting different aspects of a process of tabletop scenario co-piloting;

FIG. 2 is a block diagram depicting a data processing system adapted to perform one of the aspects of the process of FIG. 1; and,

FIG. 3 is a flow chart illustrating one of the aspects of the process illustrated in FIG. 1.

### DETAILED DESCRIPTION OF THE INVENTION

Embodiments of the invention provide for tabletop scenario co-piloting. In accordance with an embodiment of the invention, once a scenario has been selected from a set of prospective scenarios in a business continuity management system, a prompt is rendered to an LLM and the LLM returns a first adverse event associated with the selected scenario. A response to the adverse event is received in the user interface to the business continuity management system and again, a prompt is formulated with the response. The LLM once again returns a new adverse event correlated to the response and the first adverse event so that a new response can be submitted to through the user interface to the LLM within a newly formulated prompt. In this way, the repeated prompting of the LLM with responses to adverse events proposed by the LLM provide an invaluable automated co-pilot to the participants of a table top scenario testing exercise.

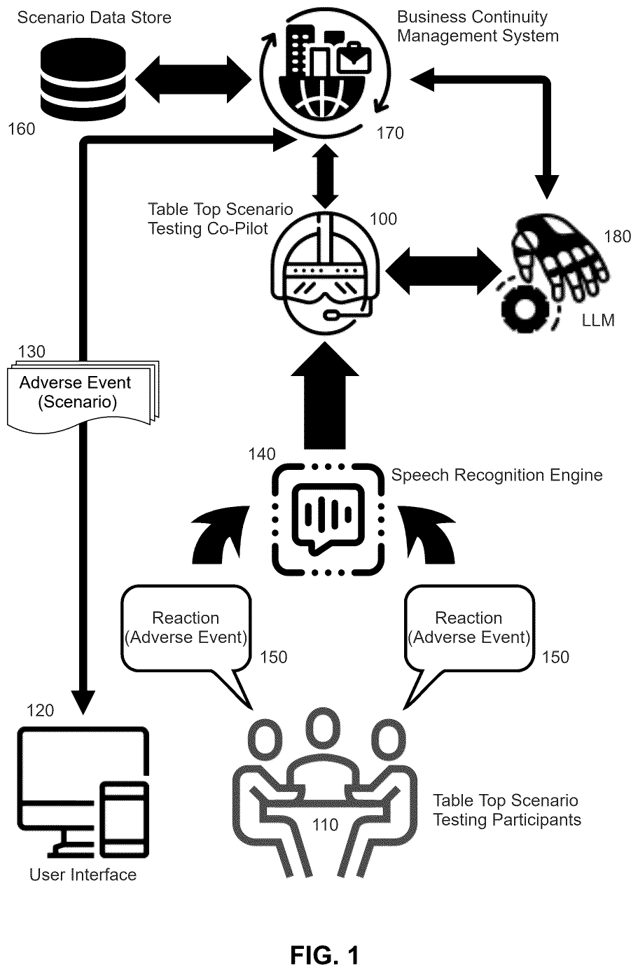

In illustration of one aspect of the embodiment, FIG. 1 pictorially shows a process of tabletop scenario co-piloting. As shown in FIG. 1, a table top scenario testing co-pilot (the “co-pilot”) 100 executes in support of a business continuity management system 170 and provides assistance to table top scenario testing participants 110 in performing a table top scenario test. Specifically, the co-pilot 100 accesses a scenario data store 160 through the business continuity management system 170 to retrieve a scenario of a multiplicity of adverse events 130, so as to tune an initial prompt as a combination of the retrieved scenario and a directive to produce an indication of an adverse event associated with the selected scenario. The co-pilot 100 then submits the tuned initial prompt to LLM 180 accessing the scenario data store 160 in order to receive in reply, one of the adverse events 130. The co-pilot 100 presents the received one of the adverse events 130 in a user interface to the co-pilot 100 for viewing by the table top scenario testing participants 110.

Thereafter, speech recognition engine 140 captures an audible reaction 150 to the received one of the adverse events 130. The speech recognition engine 140 transforms the audible reaction 150 into digital text which the co-pilot 100 uses to generate a new prompt for submission to the LLM 180. Specifically, the co-pilot 100 tunes the new prompt with the first one of the adverse events 130 and the digital text as the response to the first one of the adverse events 130 by the table top scenario testing participants 110, along with a directive to retrieve a new one of the adverse events 130 in light of the response. The co-pilot 100 then submits the follow-on prompt to the LLM 180 and receives in response a new one of the adverse events 130. The co-pilot 100, as before, presents the new one of the adverse events 130 in the user interface 120 for consideration by the table top scenario participants 110. The foregoing process repeats for a predetermined number of iterations, or until a terminate scenario directive is received in the co-pilot 100 from the table top testing participants 110.

Upon termination of the table top scenario test, the co-pilot generates a summary document documenting the adverse events 130 received from the LLM 180 and digital text as responses to the adverse events 180 from the table top scenario testing participants 110 in connection with the selected scenario. Optionally, the audible responses 150 are stored in connection with the summary document. As an additional option, the entirety of audio input received during the table top scenario exercise is submitted to the speech recognition engine 140 to produce a transcript also to be stored in connection with the summary document.

Notably, the co-pilot 100 post-processes the summary document by loading the document into memory and extracting individual tokens. Then, after having filtered the tokens to exclude stop words, the co-pilot 100 submits the filtered tokens to an indexer in order to produce an index of unique instances of words in the filtered tokens including a frequency of appearance of each of the unique instances of the words. Then, the co-pilot 100 stores the index in connection with the summary document so as to support subsequent queries against the index to correlate the most common individual words (ideas, concerns, concepts) associated with the scenario associated with the summary document. To that end, the co-pilot 100 can retrieve multiple different indices stored in connection with a particular tabletop scenario resulting from different table top scenario testing sessions in order to identify ones of the unique instances of the words with a threshold frequency of appearance across all of the indices. Then, the co-pilot 100 assigns a flag for specific indices in which the unique instances of the words lack the threshold frequency. In this way, anomalous table top scenario testing sessions corresponding to the specific indices can be identified for study.

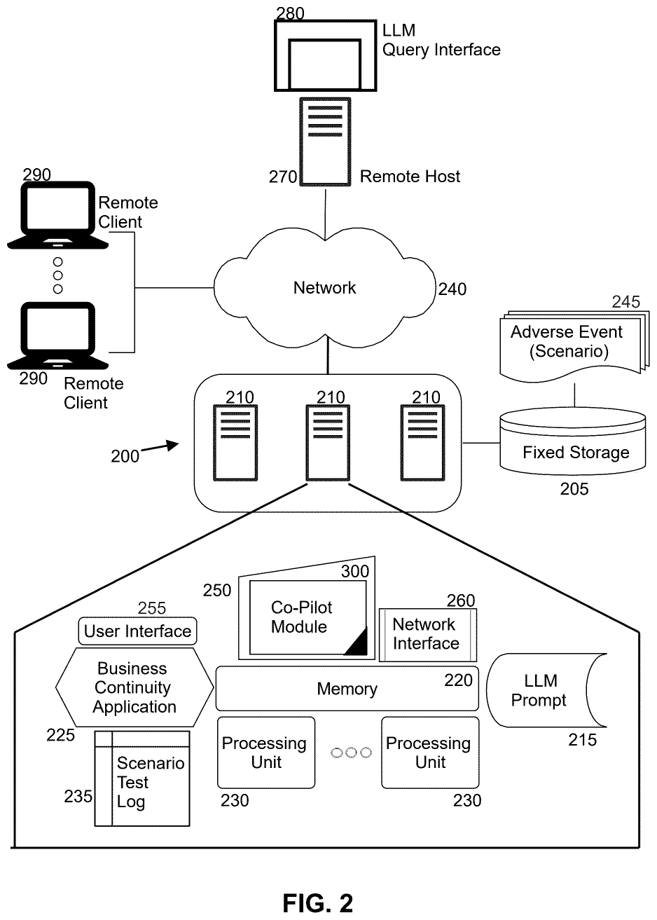

Aspects of the process described in connection with FIG. 1 can be implemented within a data processing system. In further illustration, FIG. 2 schematically shows a data processing system adapted to perform tabletop scenario co-piloting. In the data processing system illustrated in FIG. 1, a host computing platform 200 is provided. The host computing platform 200 includes one or more computers 210, each with memory 220 and one or more processing units 230. The computers 210 of the host computing platform (only a single computer shown for the purpose of illustrative simplicity) can be co-located within one another and in communication with one another over a local area network, or over a data communications bus, or the computers can be remotely disposed from one another and in communication with one another through network interface 260 over a data communications network 240.

The host computing platform 200 includes fixed storage 205 storing therein records 245 of different adverse events for different test scenarios. The host computing platform 200 further supports the operation of a business continuity application 225 in the memory 220 supporting scenario testing of scenarios by different participants to a table top scenario testing exercise through respective remote clients 290. To that end, the remote clients 290 access the business continuity applciation 225 by way of user interface 255. Of note, the host computing platform 200 also is communicatively coupled over the data communications network 240 to a remote host 270 supporting the operation of an LLM query interface 280. The LLM query interface 280 receives LLM prompts and processes those prompts in connection with an LLM accessing the records 245 of the fixed storage 205 so as to produce a response to the prompts. The LLM query interface 280 returns the responses to the host computing platform 200 over the data communications network 240 for display in the user interface 255.

Importantly, a computing device 250 including a non-transitory computer readable storage medium can be included with the data processing system 200 and accessed by the processing units 230 of one or more of the computers 210. The computing device stores 250 thereon or retains therein a program module 300 that includes computer program instructions which when executed by one or more of the processing units 230, performs a programmatically executable process for tabletop scenario co-piloting. Specifically, the program instructions during execution access business continuity application 225 to receive a selection by one of the remote clients 290 through the user interface 255 of a scenario. Thereafter, the program instructions generate a prompt 215 for transmission over the data communications network 240 to the LLM query interface 280 including the selected scenario and a network endpoint for the records 245 of the fixed storage 205.

Thereafter, the program instructions receive a reply from the LLM query interface 280 in the form of a reference to an adverse event in the records 245. The program instructions process the reply by formatting the reply for presentation through the user interface 255. Subsequently, the program instructions receive a reaction to the reply in the user interface 255 and generate a new prompt 215 for submission to the LLM query interface 280 including a reference to the scenario, the adverse event and the reaction. The LLM query interface 280 in turn produces a new reply which the program instructions format for presentation through the user interface 255. The program instructions repeat the foregoing process a discrete number of times. At the conclusion of a series of iterations, the program instructions write a log 235 in the memory 220 of the scenario, the adverse events and the reactions.

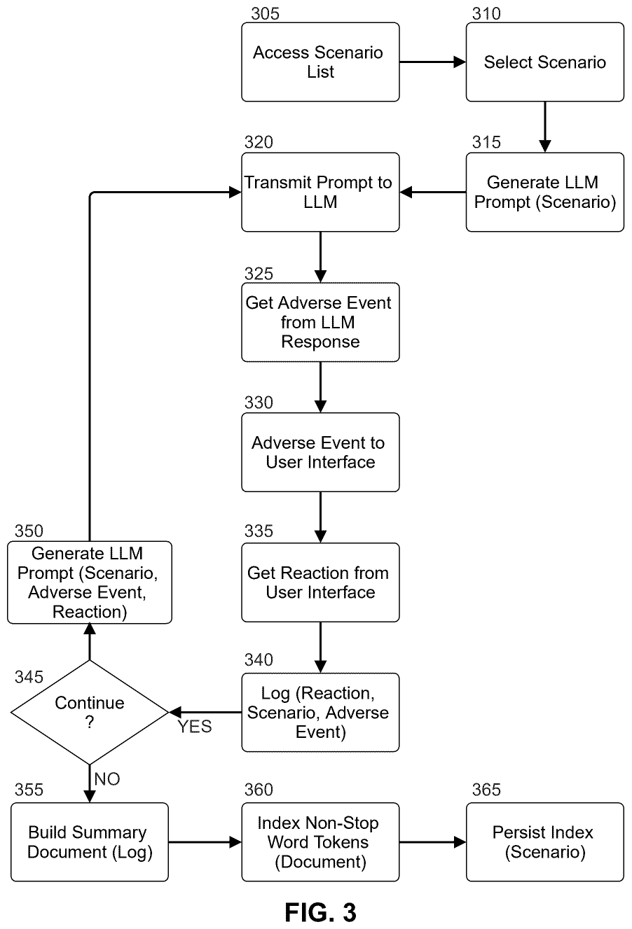

In further illustration of an exemplary operation of the module, FIG. 3 is a flow chart illustrating one of the aspects of the process of FIG. 1. Beginning in block 305, a list of scenarios can be accessed to select a particular one of the scenarios for scenario testing in a business continuity management system in block 310. In block 315, a prompt is generated for transmission to an LLM with the scenario and in block 320, the prompt is transmitted to the LLM with reference to a data store of adverse events. In block 325, an adverse event is received from the LLM in reply to the prompt and in block 330, the adverse event is presented in a user interface to the business continuity management system.

In block 335, a reaction to the adverse event is received in the user interface from participants to a tabletop scenario testing exercise and in block 340, the adverse event and the response are written to a log for the testing exercise of the scenario. In decision block 345, it is determined whether or not to terminate the exercise. If not, in block 350, a new LLM prompt is generated with reference to the scenario, the adverse event and the reaction and in block 320, the new LLM prompt is transmitted to the LLM. The process then continues as before through block 325. However, if in decision block 345 it is determined to terminate the exercise of the scenario, in block 355 a summary document is generated from the log. As well, in block 360 an index is constructed of filtered non-stop words from the reactions of the log and in block 365, the index is stored in connection with the scenario for subsequent analysis.

Of import, the foregoing flowchart and block diagram referred to herein illustrate the architecture, functionality, and operation of possible implementations of systems, methods, and computing devices according to various embodiments of the present invention. In this regard, each block in the flowchart or block diagrams may represent a module, segment, or portion of instructions, which includes one or more executable instructions for implementing the specified logical function or functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

More specifically, the present invention may be embodied as a programmatically executable process. As well, the present invention may be embodied within a computing device upon which programmatic instructions are stored and from which the programmatic instructions are enabled to be loaded into memory of a data processing system and executed therefrom in order to perform the foregoing programmatically executable process. Even further, the present invention may be embodied within a data processing system adapted to load the programmatic instructions from a computing device and to then execute the programmatic instructions in order to perform the foregoing programmatically executable process.

To that end, the computing device is a non-transitory computer readable storage medium or media retaining therein or storing thereon computer readable program instructions. These instructions, when executed from memory by one or more processing units of a data processing system, cause the processing units to perform different programmatic processes exemplary of different aspects of the programmatically executable process. In this regard, the processing units each include an instruction execution device such as a central processing unit or “CPU” of a computer. One or more computers may be included within the data processing system. Of note, while the CPU can be a single core CPU, it will be understood that multiple CPU cores can operate within the CPU and in either instance, the instructions are directly loaded from memory into one or more of the cores of one or more of the CPUs for execution.

Aside from the direct loading of the instructions from memory for execution by one or more cores of a CPU or multiple CPUs, the computer readable program instructions described herein alternatively can be retrieved from over a computer communications network into the memory of a computer of the data processing system for execution therein. As well, only a portion of the program instructions may be retrieved into the memory from over the computer communications network, while other portions may be loaded from persistent storage of the computer. Even further, only a portion of the program instructions may execute by one or more processing cores of one or more CPUs of one of the computers of the data processing system, while other portions may cooperatively execute within a different computer of the data processing system that is either co-located with the computer or positioned remotely from the computer over the computer communications network with results of the computing by both computers shared therebetween.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for tabletop scenario co-piloting comprising:
(A) establishing a communicative coupling over a computer communications network between a computer-generated business continuity management user interface of the business continuity management system and a selected large language model (LLM);
(B) selecting in the user interface a scenario as a subject of a tabletop scenario collaborative activity;
(C) tuning an initial prompt as a combination of the selected scenario and a directive to produce an indication of an adverse event associated with the selected scenario, submitting the tuned initial prompt over the communicative coupling to the LLM and receiving in reply, the indication of the adverse event, the business continuity management system presenting the indication of the adverse event in the user interface;
(D) receiving through the user interface a specification of a reaction to the adverse event;
(E) tuning a subsequent prompt with the reaction, submitting the tuned subsequent prompt over the communicative coupling to the LLM, receiving in reply, an indication of a further adverse event, the business continuity management system presenting the indication of the further adverse event in the user interface; and,
(F) repeating the steps (D) and (E) a discrete number times.

2. The method of claim 1, further comprising generating a summary document documenting a sequence of prompts and replies of the tabletop scenario collaborative activity and persisting the summary document to persistent storage in connection with the selected scenario.

3. The method of claim 2, further comprising:
receiving audio input of the tabletop scenario collaborative activity;
submitting the received audio input to a speech recognition engine to produce a transcript of the tabletop scenario collaborative activity; and,
storing the transcript in the persistent storage in connection with the tabletop scenario collaborative activity.

4. The method of claim 2, further comprising:
extracting individual tokens of the summary document;
filtering the tokens to exclude stop words;
building an index of unique instances of words in the filtered tokens including a frequency of appearance of each of the unique instances of the words; and,
storing the index in the persistent storage in connection with the tabletop scenario collaborative activity.

5. The method of claim 4, further comprising:
retrieving a multiplicity of different indices storage in the persistent storage in connection a corresponding tabletop scenario collaborative activity for a common scenario;
identifying ones of the unique instances of the words with a threshold frequency of appearance in different ones of the indices; and,
assigning a flag for others of the indices in which the unique instances of the words lack the threshold frequency.

6. A data processing system adapted for tabletop scenario co-piloting, the system comprising:
a host computing platform comprising one or more computers, each with memory and one or processing units including one or more processing cores;
a business continuity management system executing in the memory of the host computing platform and generating a user interface through which data input is received for the business continuity management system and through which data output is provided by the business continuity management system;
a communicative coupling between the host computing platform and a large language model (LLM); and,
a tabletop scenario co-piloting module comprising computer program instructions enabled while executing in the memory of at least one of the processing units of the host computing platform to perform:
(A) selecting in the user interface a scenario as a subject of a tabletop scenario collaborative activity;
(B) tuning an initial prompt as a combination of the selected scenario and a directive to produce an indication of an adverse event associated with the selected scenario, submitting the tuned initial prompt over the communicative coupling to the LLM and receiving in reply, the indication of the adverse event, the business continuity management system presenting the indication of the adverse event in the user interface;
(C) receiving through the user interface a specification of a reaction to the adverse event;
(D) tuning a subsequent prompt with the reaction, submitting the tuned subsequent prompt over the communicative coupling to the LLM, receiving in reply, an indication of a further adverse event, the business continuity management system presenting the indication of the further adverse event in the user interface; and,
(E) repeating the steps (C) and (D) a discrete number times.

7. The system of claim 6, wherein the program instructions further perform generating a summary document documenting a sequence of prompts and replies of the tabletop scenario collaborative activity and persisting the summary document to persistent storage in connection with the selected scenario.

8. The system of claim 7, wherein the program instructions further perform:
receiving audio input of the tabletop scenario collaborative activity;
submitting the received audio input to a speech recognition engine to produce a transcript of the tabletop scenario collaborative activity; and,
storing the transcript in the persistent storage in connection with the tabletop scenario collaborative activity.

9. The system of claim 7, wherein the program instructions further perform:
extracting individual tokens of the summary document;
filtering the tokens to exclude stop words;
building an index of unique instances of words in the filtered tokens including a frequency of appearance of each of the unique instances of the words; and,
storing the index in the persistent storage in connection with the tabletop scenario collaborative activity.

10. The system of claim 9, wherein the program instructions further perform: retrieving a multiplicity of different indices storage in the persistent storage in connection a corresponding tabletop scenario collaborative activity for a common scenario;
identifying ones of the unique instances of the words with a threshold frequency of appearance in different ones of the indices; and,
assigning a flag for others of the indices in which the unique instances of the words lack the threshold frequency.

11. A computing device comprising a non-transitory computer readable storage medium having program instructions stored therein, the instructions being executable by at least one processing core of a processing unit to cause the processing unit to perform tabletop scenario co-piloting by:
(A) establishing a communicative coupling over a computer communications network between a computer-generated business continuity management user interface of the business continuity management system and a selected large language model (LLM);
(B) selecting in the user interface a scenario as a subject of a tabletop scenario collaborative activity;
(C) tuning an initial prompt as a combination of the selected scenario and a directive to produce an indication of an adverse event associated with the selected scenario, submitting the tuned initial prompt over the communicative coupling to the LLM and receiving in reply, the indication of the adverse event, the business continuity management system presenting the indication of the adverse event in the user interface;
(D) receiving through the user interface a specification of a reaction to the adverse event;
(E) tuning a subsequent prompt with the reaction, submitting the tuned subsequent prompt over the communicative coupling to the LLM, receiving in reply, an indication of a further adverse event, the business continuity management system presenting the indication of the further adverse event in the user interface; and,
(F) repeating the steps (D) and (E) a discrete number times.

12. The device of claim 11, wherein the instructions of the device cause the processing unit to perform tabletop scenario co-piloting by further generating a summary document documenting a sequence of prompts and replies of the tabletop scenario collaborative activity and persisting the summary document to persistent storage in connection with the selected scenario.

13. The device of claim 12, wherein the instructions of the device cause the processing unit to perform tabletop scenario co-piloting by further:
receiving audio input of the tabletop scenario collaborative activity;
submitting the received audio input to a speech recognition engine to produce a transcript of the tabletop scenario collaborative activity; and,
storing the transcript in the persistent storage in connection with the tabletop scenario collaborative activity.

14. The device of claim 13, wherein the instructions of the device cause the processing unit to perform tabletop scenario co-piloting by further:
extracting individual tokens of the summary document;
filtering the tokens to exclude stop words;
building an index of unique instances of words in the filtered tokens including a frequency of appearance of each of the unique instances of the words; and,
storing the index in the persistent storage in connection with the tabletop scenario collaborative activity.

15. The device of claim 14, wherein the instructions of the device cause the processing unit to perform tabletop scenario co-piloting by further:
retrieving a multiplicity of different indices storage in the persistent storage in connection a corresponding tabletop scenario collaborative activity for a common scenario;
identifying ones of the unique instances of the words with a threshold frequency of appearance in different ones of the indices; and,
assigning a flag for others of the indices in which the unique instances of the words lack the threshold frequency.
